(19) United States
(12) Patent Application Publication
(10) Pub. No.: US 2014/0143106 A1
(43) Pub. Date: May 22, 2014

(54) System and Method for Financial Notification

(71) Applicant: Family Wealth Map, LLC, Chesterfied, MO (US)

(72) Inventor: Richard Fox, Chesterfield, MO (US)

(21) Appl. No.: 14/081,646

(22) Filed: Nov. 15, 2013

Related U.S. Application Data
(60) Provisional application No. 61/727,331, filed on Nov. 16, 2012.

(51) Int. Cl. G06Q 50/18; G06Q 40/00

(52) U.S. Cl. CPC G06Q 50/186; G06Q 40/00
USPC 705/35

(57) ABSTRACT

The present invention relates to systems and methods for the aggregation and mapping of individual and familial assets. The present system and methods comprise a network-connected computer and database having means for the collection of information from the user, the user's online accounts and third-party databases, such as public records databases, for use by the system and methods, as well as the preparation for distribution of the user's assets to their heirs following death.

### CROSS-REFERENCE TO RELATED APPLICATION(S)

This application claims priority to claims priority to U.S. Provisional Application No. 61/727,331, filed on Nov. 16, 2012 and entitled “Financial Family Tree Software” which is incorporated herein by reference in its entirety for all purposes.

### FIELD OF THE INVENTION

The present invention relates to financial asset aggregation and management through the use of software tied to the social security administration.

### BACKGROUND OF THE INVENTION

As data processing and storage capabilities have improved, various financial institutions and other entities have begun to provide online services for tracking one's assets and liabilities. Users have come to rely on these capabilities to more effectively and efficiently gather, store, and use various forms of financial data. However, the use of these online tracking methods fails to give a user, or their family, a complete picture of the complete financial and legal status of an individual or family, as not all factors are taken into account. Further, upon a person's death, existing financial and legal information is difficult to collect from the various and disparate sources.

Accordingly, there is a need in the art for systems and methods for aggregating this information for personal and familial use, both before and after death.

### BRIEF SUMMARY OF THE INVENTION

It is an object of the present invention to provide a method for financial asset aggregation, organization and facilitation for individuals and multigenerational families.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a schematic overview of key features of certain exemplary embodiments of the system.

FIG. 2 is a schematic overview of certain exemplary embodiments of the system, showing the aggregation of a user's personal information by way of the website portal.

FIG. 3 is a schematic overview of an exemplary embodiment of the system utilizing a network to aggregate information.

FIG. 4 is a representative screenshot of one embodiment of the graphical user interface of exemplary embodiments of the system.

FIG. 5 is a schematic overview of an exemplary embodiment of the system utilizing a public records in the aggregation and functionality of the system.

FIG. 6 is another schematic overview of the embodiment of FIG. 5.

FIG. 7 is another schematic overview of the embodiment of FIG. 6, showing the death notification.

FIG. 8 is a schematic overview of an exemplary embodiment of the system showing a family partnership.

FIG. 9 is a schematic overview of an exemplary embodiment of the system utilizing a professional accounts.

### DETAILED DESCRIPTION

The present invention is a financial asset aggregator, organizer and facilitator for individuals and multigenerational families. The present system provides users with the ability to aggregate financial and legal information in one online repository. In certain exemplary embodiments, the system also monitors public records relating to the user, including the social security administration, and automatically provides a unified financial accounting for the user's beneficiaries upon death. The present invention is distinct and novel based upon several unique key features which are not offered in the prior art.

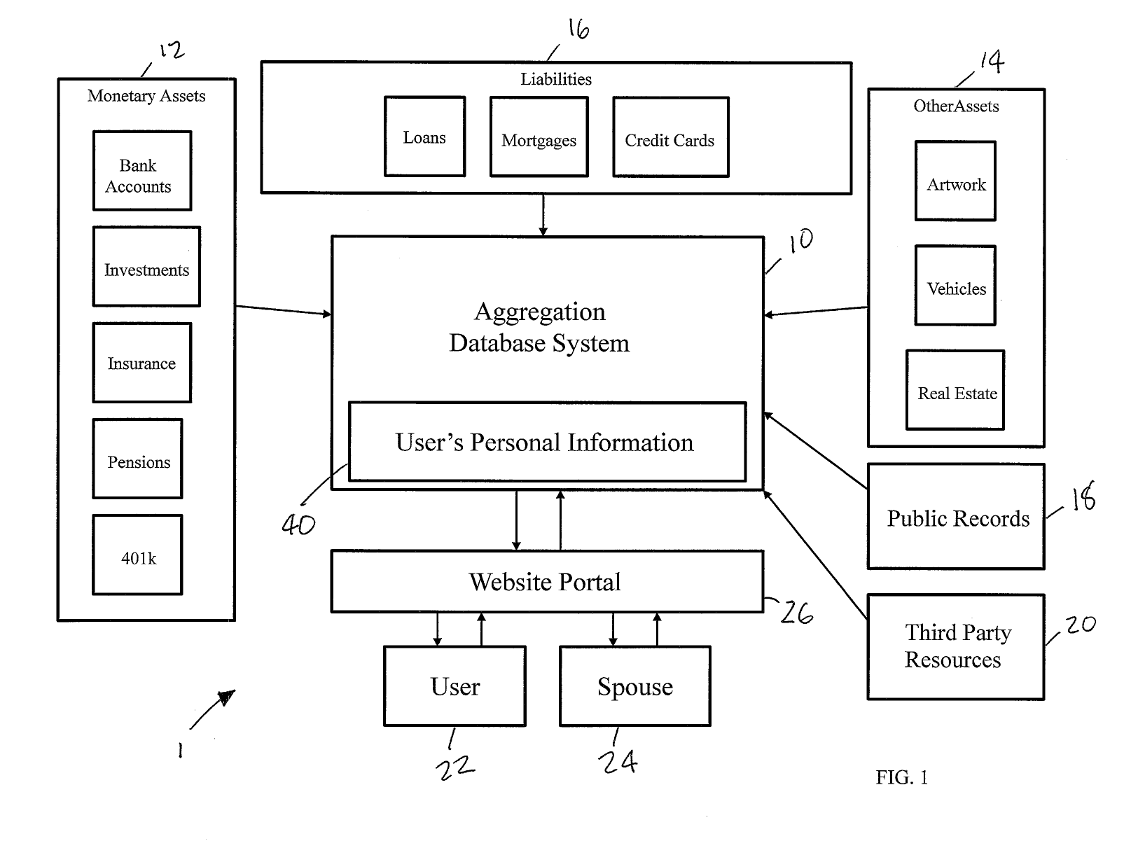

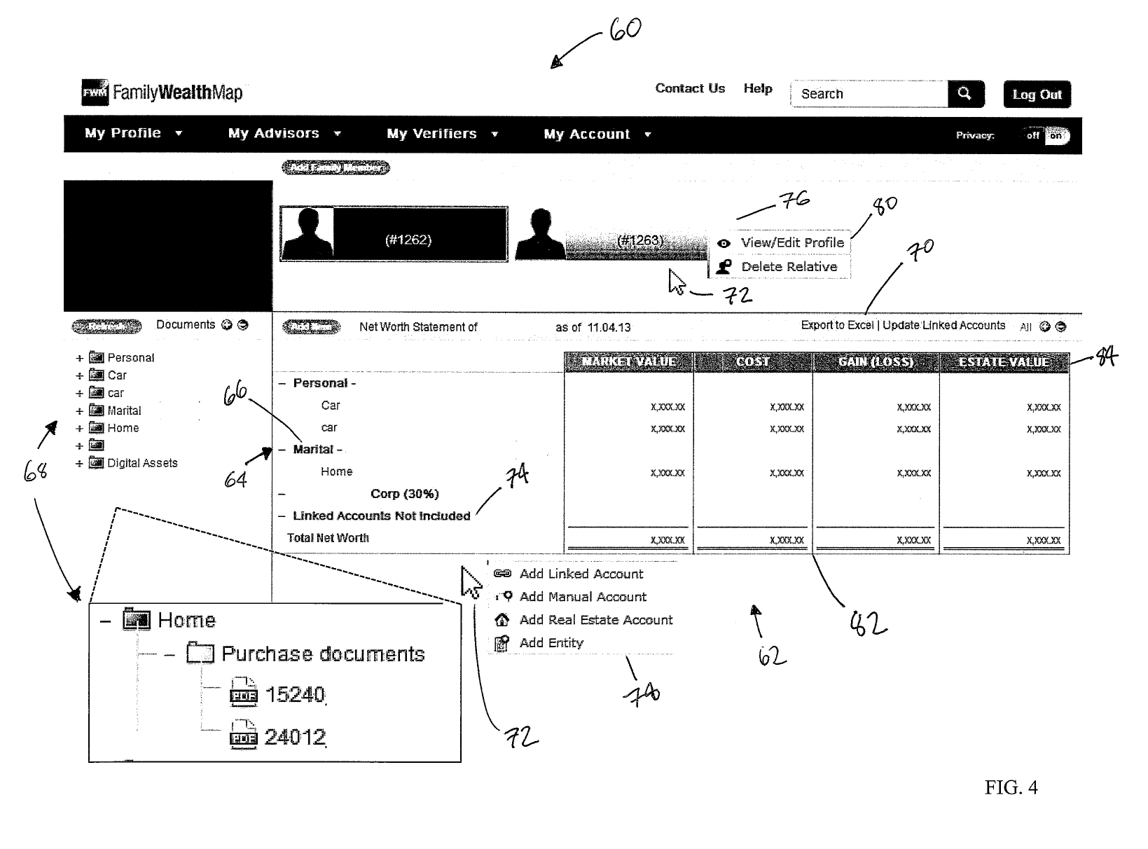

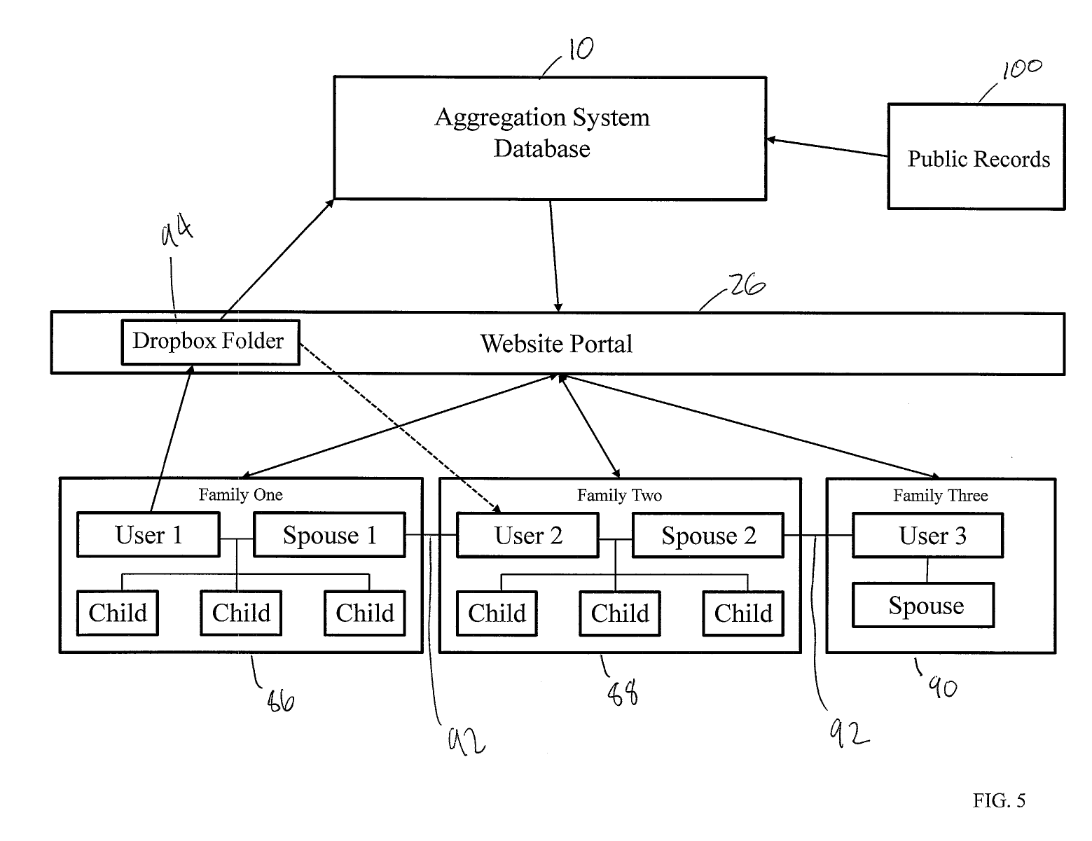

As depicted in the figures, such as FIGS. 1-3, certain embodiments of the present invention relate to the online aggregation of asset and liability information, as well as public record information, for multiple members of a family or other group. As shown in FIG. 4, certain embodiments of the present invention include net worth statements, otherwise known as a “Family Wealth Map” or simply a “Map,” which are provided to the user FIGS. 5-9 depict further embodiments of the system illustrating various embodiments of the system. While the present invention is generally referred to as a “system” for brevity, associated methods and apparatus also fall within the scope of the described embodiments.

Turning to the figures in more detail, FIG. 1 depicts an overview of the aggregation and notification system 1. In certain embodiments, this system may feature a database 10 used to aggregate various types of financial assets, both monetary 12 and otherwise 14, and whether directly accessible or deducible by way of other means, as will be described in further detail herein. As shown in the embodiment of FIG. 1, in certain embodiments, these assets 12, 14 and liabilities 16 may include checking and savings accounts, investments, life insurance, loans, real estate, artwork, autos, aircraft, mortgages, rewards programs, 401k, pensions, credit cards and the like. Digital assets can also be utilized, such as Facebook accounts, email accounts, airline rewards programs and the like. Other assets are of course possible, as would be apparent to one of skill in the art.

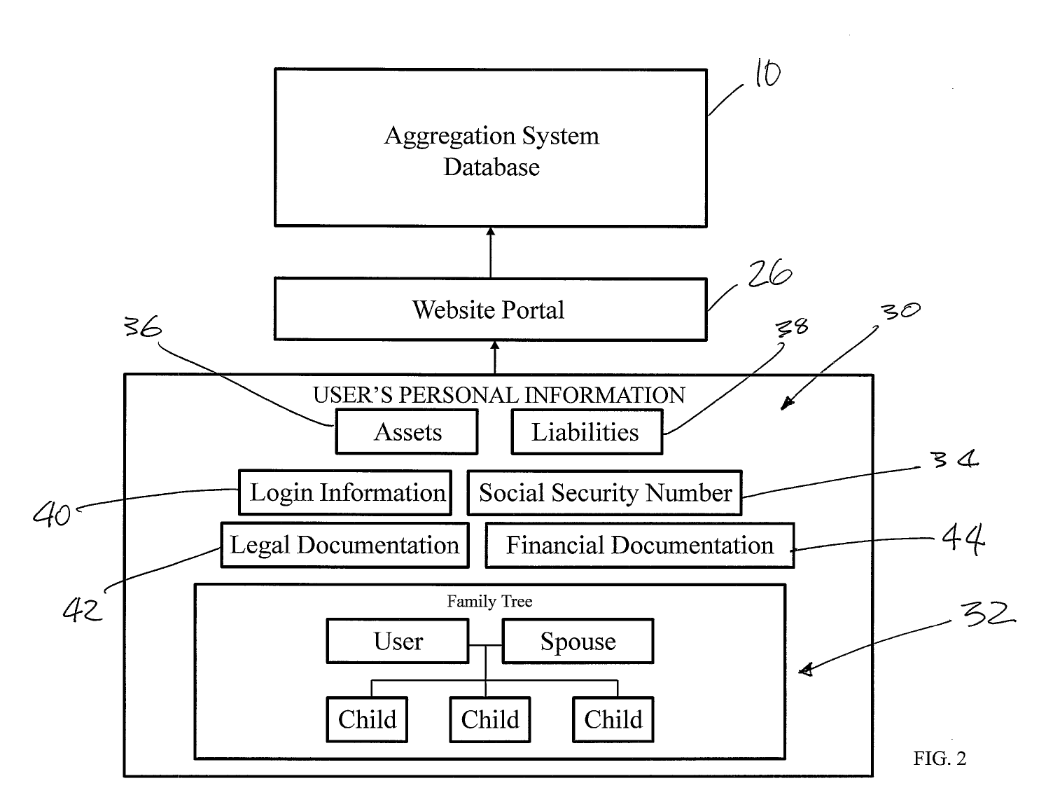

These assets 12, 14, liabilities 16 and other information are described herein as such, but the values can be aggregated by accessing certain public records 18, online accounts, such as bank or 401k accounts, third-party resources 20, and/or other resources, as would be apparent. In certain embodiments, liabilities 16, such as debts and other negative values, loans, mortgages and the like are also included by similar means. As described in reference to FIG. 2, the aggregation database system also securely stores personal information about the user 40 for use in compiling the data and providing information to the user and his or her spouse 26 or other beneficiaries.

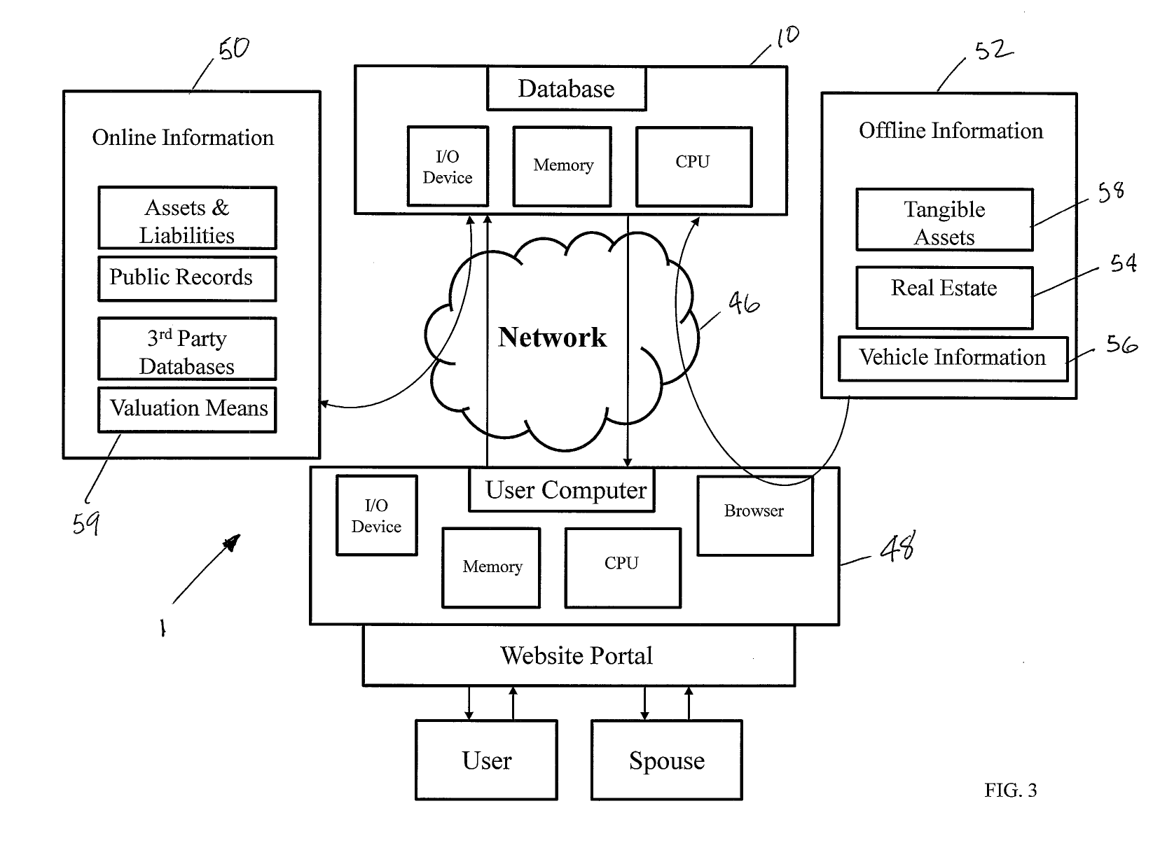

As is further shown in FIGS. 1 and 3, in certain exemplary embodiments this aggregation is accessible by the user 22, and for example, by the user's spouse 24. Other configurations of access by way of user accounts via a website portal 26 are possible, as would be apparent to one of skill in the art.

As is shown in FIG. 2, in exemplary embodiments of the system 1, when a user 24 creates an account on the website 26, the user is required to enter a variety of personal information 30 into the database. In certain embodiments, the user will be prompted to enter information about his or her spouse, partner, family members, or other parties of financial interest to the user 32. Further information such as the user's social security number 34, bank account and other asset 36 and liability 38 information may be entered, as well as login information 40 such as usernames and passwords required for accessing online accounts. Other basic information such as address, date of birth, name, occupation, and the like may also be collected.

As is also shown in FIG. 2, further embodiments of the system further comprise document storage. Many prior art programs provide online document storage, but they fail to link documents to accounts on a net worth statement. In certain exemplary embodiments, the user 24 may also upload certain legal 42 and financial 44 documentation, such as copies of user's last will and testament, deed or deeds to the user's real estate, marriage license, birth certificates for the user and their family, contracts, bills of sale, and other such documentation. Linking documents to specific accounts is a practical way to organize and retrieve those documents. For example, documents pertaining to a particular piece of real estate can be accessed by selecting the real estate account by “clicking” and “highlighting” the account name on the website of the present invention, as discussed further in reference to FIG. 4. By way of example, when the real estate account is selected, documents such as mortgages, deeds, insurance policies, appraisals, and the like all appear in the document frame and can be accessed, downloaded, printed, shared or uploaded. The user may also create folders and subfolders to organize the documents.

As shown in FIG. 3, exemplary embodiments of the system 1 utilize a computer network 46 such as the internet to connect the user's computer 48 to the database 10. The system 1 also utilizes the network 46 to collect information from other websites or online databases 50, such as account information, social security records, mortgage records, stock prices, and the like, as described in reference to FIG. 2. Certain other kinds of “offline” information 52, such as real estate values 54, vehicle values 56, and other asset and liability information 58, can be gathered by the system 1 and database 10, and valued by way of certain third party valuation websites 59 such as Zillow, Trulia, Kelly Blue Book and the like.

In certain exemplary embodiments of the system, the user's address, vehicle identification number, and other such information may be entered so that the system 1 can access such third party information. In certain alternative embodiments, the user can enter the value of their assets manually. Jewels, precious metals, furs, artwork, and other appraised or titled assets of this sort may be entered this way as well and stored by the database 10.

As is shown in FIG. 4, exemplary embodiments of the system 1 comprise a graphical user interface 60 at the web portal level, which can be depict summaries 62 showing broad classifications of assets, and/or the user's individual assets 64, as well as those of their spouse, partner, family members, or other parties 66. These summaries 62, or “maps,” can thus serve as an interface for the user to access information aggregated by the system, make decisions about those assets, and otherwise interact with the system, as described herein. As discussed in relation to FIG. 3, in certain embodiments, the values within the system are automatically updated daily to reflect the current balances and market values of cash and marketable securities, which is reflected on the map.

In exemplary embodiments, the user may be provided with a folder system 68, which allows for document storage and other organizational tools, as also discussed in relation to FIG. 3. In certain exemplary embodiments, the values for the user's assets may be refreshed in real-time, or hourly, or daily, or the like. Other items in the system can be manually adjusted as often as necessary, to reflect appreciation or depreciation of the value of the various assets and/or debts. In certain embodiments, this information can also be exported by the user to Excel 70 or other such software for storage and further functionality.

In certain exemplary embodiments, the user interacts with the map utilizing the right click button 72. In these embodiments, right clicking on the names of accounts 74 or users 76 and the like will bring up interactive menus 78, 80 which can be used to view or change assets, add accounts, add liabilities and the like for individual users, as well as delete users or perform other functions, as would be apparent to one of skill in the art.

As also discussed in relation to FIGS. 3-4, in exemplary embodiments, the system may also calculate or otherwise gather the current market value of these assets as well as other factors such as the cost basis 82 and estate values 84. Certain exemplary embodiments utilize cost basis 82 information. In these embodiments, the system will capture and retain the cost basis of financial assets. This is an important feature to have when assets are sold or transferred because it establishes the net profit or loss for tax purposes. For example, if the cost basis is not available when the asset is sold, all of the proceeds are considered ordinary income and taxed accordingly at higher rates.

Thus, a key feature of certain embodiments is a mark-to-market net worth statement provided to users. In certain embodiments of the system, financial accounts held by banks and other financial institutions will have their balances updated periodically, in some embodiments at least daily. In these exemplary embodiments, each day's net worth statement is retained and can be retrieved by the user or other parties with access to the user's account. Such updating provides a needed feature for accountants who need to know values on specific dates for tax sensitive events such as gifting and estate tax calculations.

An additional key feature of certain embodiments of the system is the ability to evaluate and aggregate shared assets and provide partial value reporting, as is shown in FIG. 4. This feature is a unique solution to a real life situation of having assets that are shared, for example assets jointly owned with other family members 66. In the past, assets were simply transferred in whole to a decedent's heirs. Titles to assets such as real estate, common stock, cash, and the like were simply transferred to heirs upon the death of a user. Today, for more efficient estate planning reasons, assets are transferred into estate friendly entities during the life of the user, and partial interests in those entities are transferred to heirs over several years. Such entities can include corporations, partnerships, trusts, and the like. Current aggregation products only report entire balances of assets in a user's account, but do not provide for the possibility that the user may only own a partial interest in such assets through their shared ownership in a holding entity. By including the value of the entire asset, a user's net worth is overstated. Shared asset and partial value accounting, on the other hand, reflects the true value of the assets owned by the user.

Further, certain exemplary embodiments of the system provide the user or the user's financial professional, advisor, or council with estate value information 84. In certain exemplary embodiments, the system will also reflect the estate value of the user's financial assets. This is an important feature for because it allows professional advisors to help their clients (individual users) plan for the potential liability of estate taxes upon their death. If there is an estate tax liability, and the user's assets are illiquid, having the estate values readily at hand facilitates the determination of the amount of life insurance needed to pay the estate tax. It will also help professional advisors guide their clients (users) through various estate planning techniques designed to reduce estate taxes.

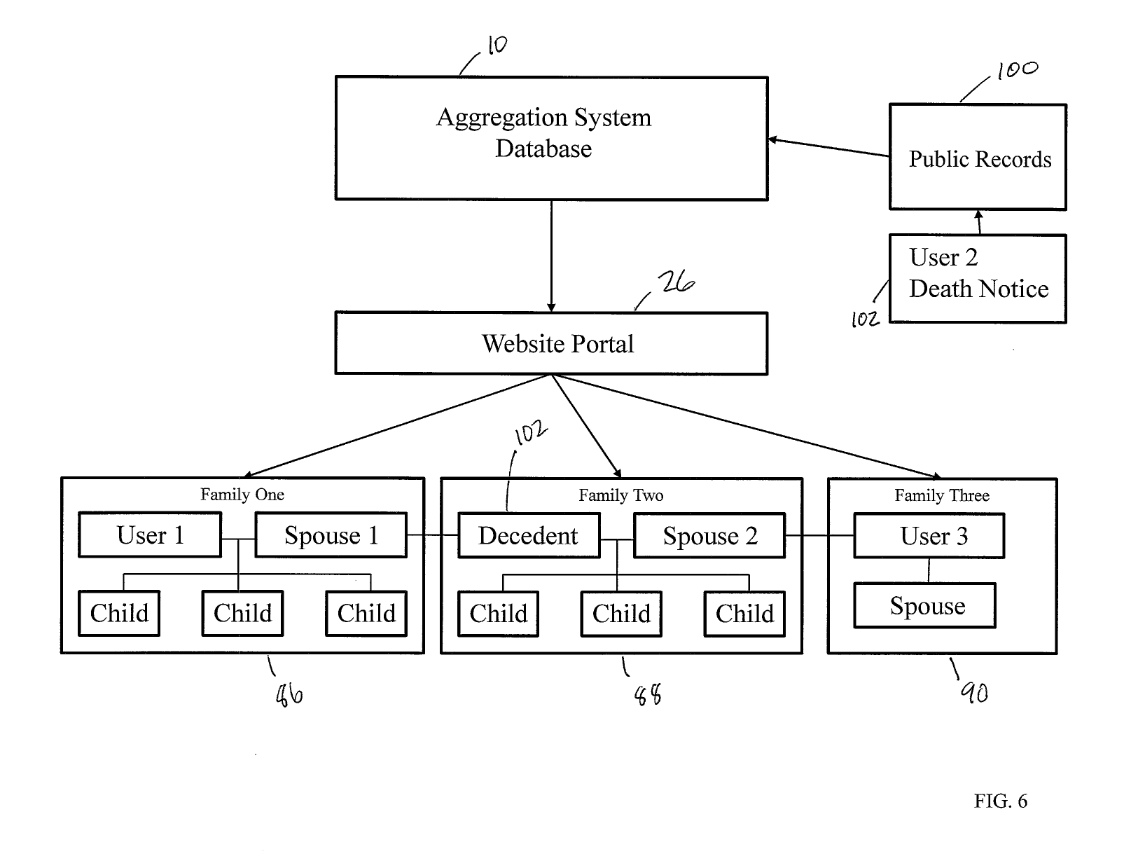

As depicted in FIG. 5-6, two additional key features of exemplary embodiments of the system are account linking and notification upon death, which is wholly unique to the present system. As shown in FIG. 5, in embodiments comprising account linking (also referred to as “linked family maps”) the system comprises the ability to link the maps or accounts of several family members, both within a nuclear unit 86 and between further units 88, 90. In these embodiments, the maps are “linked” 92 when an asset has been shared with another family member. Linking maps allows the respective family members to view values of shared assets and, with the proper authorization, the documents associated therewith. These embodiments allow the system to relate financial and legal information within and between families, so as to more accurately reflect, for example, the nature of probate.

Simply linking maps, however, does not necessarily allow family members to view any asset or document that is associated with a shared asset. In these embodiments, the system allows the user or users to control the sharing of information related to such assets and documents as desired. In certain embodiments, entire folders of documents, or subfolders can be shared. In certain embodiments, this can be achieved by way of a direct link to a dropbox folder 94. In certain embodiments, the user can set an expiration date on the file, so that it will only be available to the other family member for a limited amount of time.

As shown in FIG. 6, certain exemplary embodiments comprise a notification upon death feature will allow the system to “learn” of a user's death without any input by any individual. This feature is important because an organizational aspect of the system is that it provides information for heirs in the event of death. Unless the user leaves instructions as to how to access their map, the user's heirs may not know of the all of the user's accounts or may have difficulty accessing the information contained therein whilst going through probate. Notification upon death utilizes a national database of information about deceased persons, such as the Social Security database or other national database of public records 100. In these embodiments, the system will compare the user's information against such a national database 100 to determine if any of its clients have died.

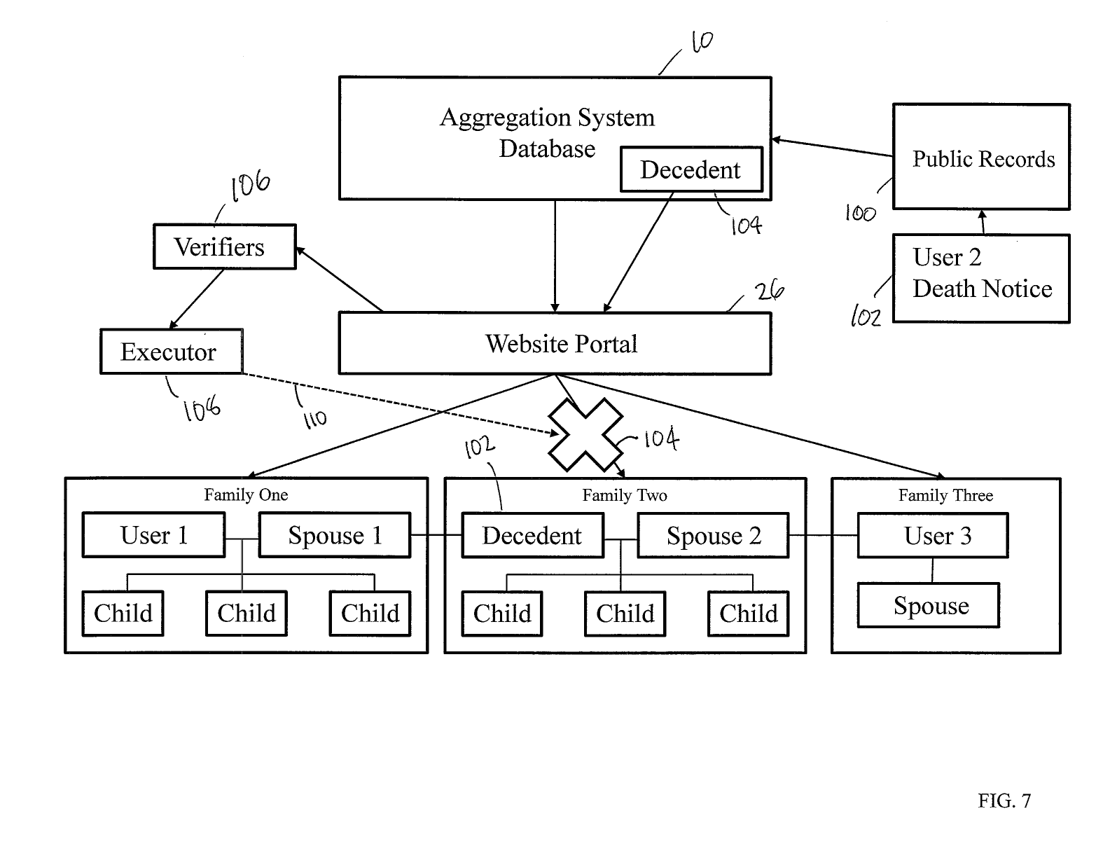

As is also shown in FIGS. 6-7, and by way of example, if the system detects a decedent match 102, a sequence of events may occur. Other sequences are possible. In an exemplary embodiment, the sequence may be that the system will first shut-down access 104 to the account to protect the information therein. Second, notification will be sent to the “verifiers” 106 selected by the client when the account was established with specific information about how to proceed. Third, these verifiers will contact the decedent's executor 108 or court appointed administrator and inform them of the existence of the decedent's family wealth map account. Fourth, upon proper verification of the authorized representative's identity and authority the system will create a new user name and password for the representative with certain limited features that allow the representative to access the account 110, obtain certain necessary information, and wind down and ultimately terminate the account of the decedent 102.

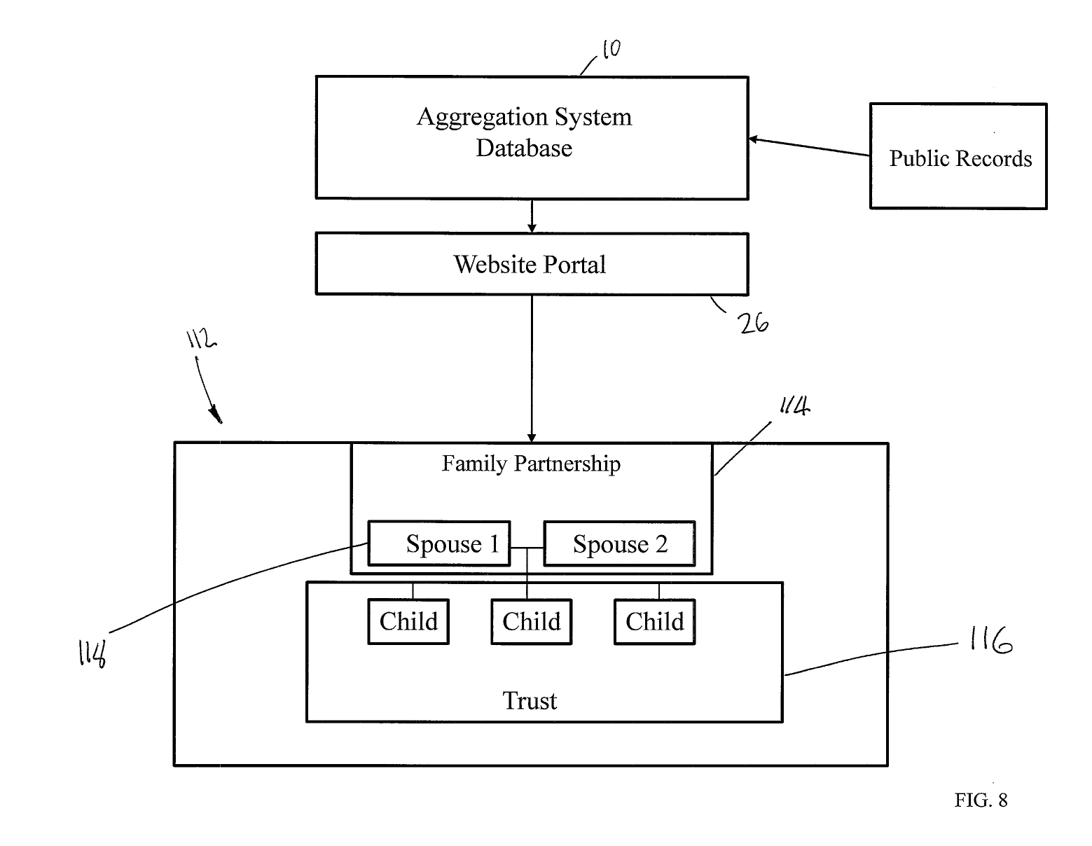

FIG. 8 depicts further features of exemplary embodiments of the system. Another key feature of certain embodiments of the system is referred to herein as “account grouping,” 112 which is distinct from the account linking described above. In certain exemplary embodiments, accounts may be held in one's name, or in distinct entities such as family limited partnerships 114, trusts 116, corporations, etc. The system will group these accounts together 112, showing both the value of the individual accounts 118 as well as the value of all accounts within the entity. This is important because assets held in entities have the possibility of having a lower estate value and may be shared with other owners of the entity. By grouping the accounts by owner, the system is able to reflect the true ownership and value of assets.

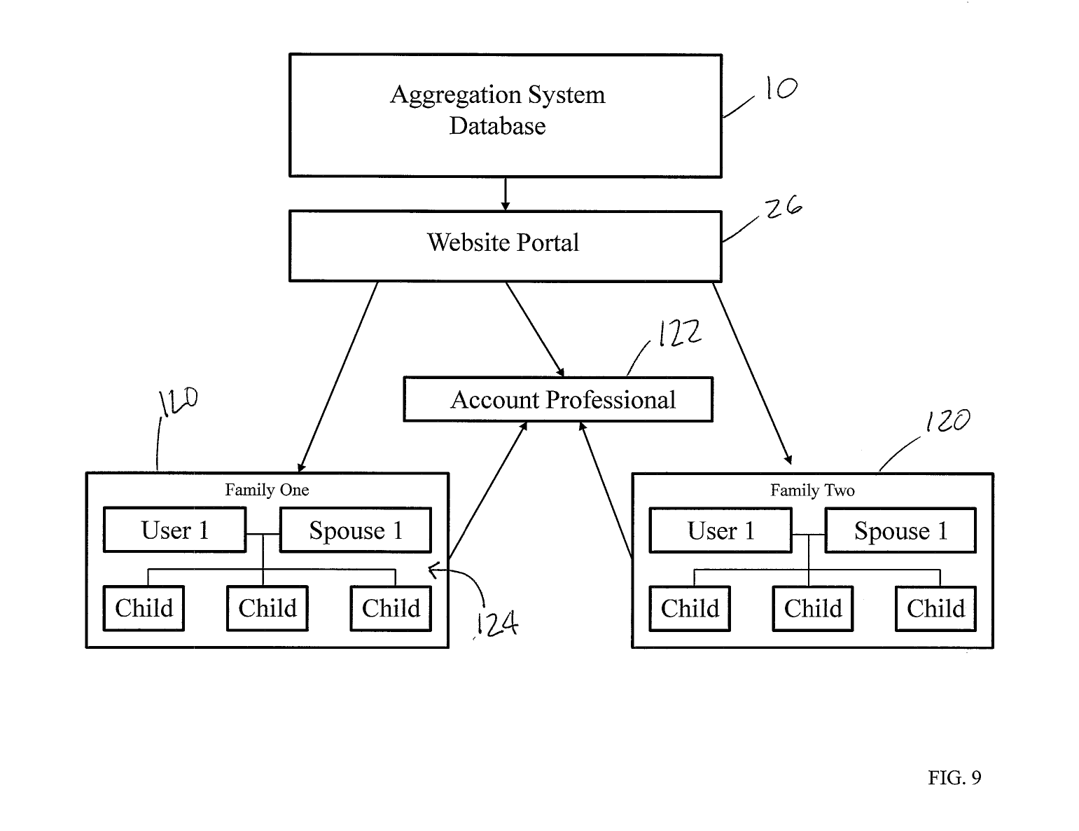

FIG. 9 depicts an exemplary embodiments of the system comprising both individual 120 and professional 122 accounts. The system thus encompasses certain embodiments that can be used by individual users and embodiments that can be utilized by professional advisors. By way of example, an individual account is a single user account. In such embodiments, a user will have access to most or all of the features, but only has the ability to create one “family” account. For example, they will only be able to create a single family tree 124 of maps and documents. In other embodiments, the professional advisor account 122, on the other hand, has the ability to create and manage multiple “user family” accounts. Each user family will have its own family tree and associated documents, but each user family is separate and distinct from the others. For example, an advisor with ten (10) user families, can create a map for each user family. Each map can be accessed by that professional advisor with one user name and password and the professional advisor can switch between user families easily. These innovations represent significant improvements over the prior art. Certain embodiments of the system also comprise an activity log. The activity log contains a date and time stamped list of all activity and changes that have ever occurred within a client's account.

Although the present invention has been described with reference to preferred embodiments and certain key features, persons skilled in the art will recognize that changes may be made in form and detail without departing from the spirit and scope of the invention.

What is claimed is:

1. A system for aggregation and display of a user's financial and legal information, comprising:
a. a network-connected computer configured to communicate with third-party servers;
b. a computer server in communication with the network-connected computer, the computer server further comprising a database for aggregation and storage of financial and legal information and communicatively connected to the network by way of the network-connected computer; and
c. a website portal in communication with the computer server and database by way of the network-connected computer, further comprising secure login means for users by way of the user's internet browser, wherein the user is capable of providing financial and legal information to the database for aggregation and reporting of that information to the user.

2. The system of claim 1, further comprising a third party database, wherein the network-connected computer is capable of accessing the third party database by way of the network to provide information to the database.

3. The system of claim 2, wherein the information provided to the database is selected from the group consisting of valuation information, personal financial information, personal liability information, business financial information, real estate valuation information, automobile valuation information, art valuation information, jewelry valuation information, stock prices, bond prices, and 401k valuation information.

4. The system of claim 2, wherein the information provided to the database is public record information.

5. The system of claim 4, wherein the public record information is death notification information.

6. The system of claim 5, wherein the network-connected computer further comprises a network communication with at least one third party selected from the group consisting of a verifier, an executor, an attorney, an account professional, and a family member, wherein the network-connected computer can notify that third party of the death and provide access to information stored on the database.

7. A method for the aggregation and display of financial and legal information relating to at least one user, comprising:
d. providing a network-connected computer;
e. assembling financial and legal information about at least one user on a server database connected to the network-connected computer, wherein the assembly is performed by way of the network communicating with at least one of the group consisting of: a financial institution database, a public records institution database, and a third party commercial database;
f. compiling the financial and legal information along with personal information about the at least one user;
g. presenting the information by way of a network portal to the at least one user.

8. The method of claim 7, wherein the financial and legal information assembled on the server database is selected from the group consisting of valuation information, personal financial information, personal liability information, business financial information, real estate valuation information, automobile valuation information, art valuation information, jewelry valuation information, stock prices, bond prices, and 401k valuation information.

9. The method of claim 8, wherein the information provided to the database is information of public record.

10. The method of claim 9, wherein the public record information is death notification information.

11. The method of claim 10, wherein the network-connected computer further comprises a network communication with at least one third party selected from the group consisting of a verifier, an executor, an attorney, an account professional, and a family member, wherein the network-connected computer can notify that third party of the death and provide access to information stored on the database.

12. A method for aggregation and display of a user's financial and legal information, comprising:
a. providing a network-connected computer;
b. providing a computer server in communication with the network-connected computer, the computer server further comprising a database for aggregation and storage of financial and legal information and communicatively connected to the network by way of the network-connected computer; and
c. providing a website portal in communication with the computer server and database by way of the network-connected computer, further comprising secure login means for users by way of the user's internet browser, wherein the user is capable of providing financial and legal information to the database for aggregation and reporting of that information to the user.

13. The method of claim 12, further comprising a third party database, wherein the network-connected computer is capable of accessing the third party database by way of the network to provide information to the database.

14. The method of claim 13, wherein the information provided to the database is selected from the group consisting of valuation information, personal financial information, personal liability information, business financial information, real estate valuation information, automobile valuation information, art valuation information, jewelry valuation information, stock prices, bond prices, and 401k valuation information.

15. The method of claim 13, wherein the information provided to the database is public record information.

16. The method of claim 15, wherein the public record information is death notification information.

17. The method of claim 16, wherein the network-connected computer further comprises a network communication with at least one third party selected from the group consisting of a verifier, an executor, an attorney, an account professional, and a family member, wherein the network-connected computer can notify that third party of the death and provide access to information stored on the database.
